(19) United States
(12) Patent Application Publication
(10) Pub. No.: US 2009/0058025 A1
(43) Pub. Date: Mar. 5, 2009

(54) Shop Basket To Be Attached To Supermarket Car

(76) Inventor: Livia Maria Rolim De Oliveira, Brasiliana (BR)

Correspondence Address: RICHARD M. GOLDBERG, 25 EAST SALEM STREET, SUITE 419, HACKENSACK, NJ, 07601, US

(21) Appl. No.: 12/178,371

(22) Filed: Jul. 23, 2008

(30) Foreign Application Priority Data
Aug. 27, 2007 (BR) MU 8701895-0

(51) Int. Cl. B62D 39/00; B65D 25/28; B65D 21/032

(52) U.S. Cl. 280/33.992; 220/752; 206/509

(57) ABSTRACT

“SHOP BASKET TO BE ATTACHED TO SUPERMARKET CAR”. Utility Model Patent to a shop basket to be attached to supermarket car, which comprises a rectangular, hollow and one piece basket with central handle (2) to ease when it is taken, two supports (3) to attach it to the supermarket car, a crease (1) at each one of its side walls to allow the easy placement of goods in the basket, and semi-hollow circles (4) at its bottom, to engrave the basket owner data with a pointed tool.

This utility models patent has as purpose a shop basket model, to be used together with a new conception of supermarket cars, aiming at improving its use and efficacy compared to the other existing models, besides avoiding environment impacts.

The conventional supermarket baskets are already known. They are used exclusively apart from the supermarket cars and cannot be attached to them. There are also the conventional plastic bags, used to place the goods after their payment.

As far as the broad utilization of the conventional baskets regards, some inconvenient factors may be attributed to it, such as the fact of being used individually, limiting its use for small purchases.

Another problem is that the use of conventional baskets implies the use of plastic bags so that the consumer may carry the goods to their final destination. The plastic bags, besides being extremely burdensome to the supermarkets, generate negative environment impacts.

The use of supermarket cars with conventional baskets constitutes another problem as it does not allow the goods to be separated by section, causing squeezing, breakages or even contamination among the products.

The conventional baskets are also inconvenient, as their handles are manufactured separately and they need to be assembled to the baskets, increasing their cost and reducing their life cycle.

In acknowledgement of these problems and aiming at overcome the same, the shop basket object to this patent was developed. It consists of offering the consumer shop baskets which may be brought empty from home, attached to the supermarket car, and taken back to the consumer home full of goods, discharging the use of plastic bags, optimizing the shopping time and reducing the supermarket expenses with plastic bags and people to pack the goods. The baskets have semi-hollow engraving allowing their identification with the name of its owner or in anyway preferred.

Such basket is constituted of one stackable hollow piece, reducing thus its manufacturing cost. The central and anatomical handle making part of it substitutes the conventional double handles which need to be assembled.

The invention will be best understood through the detailed description together with the figures attached:

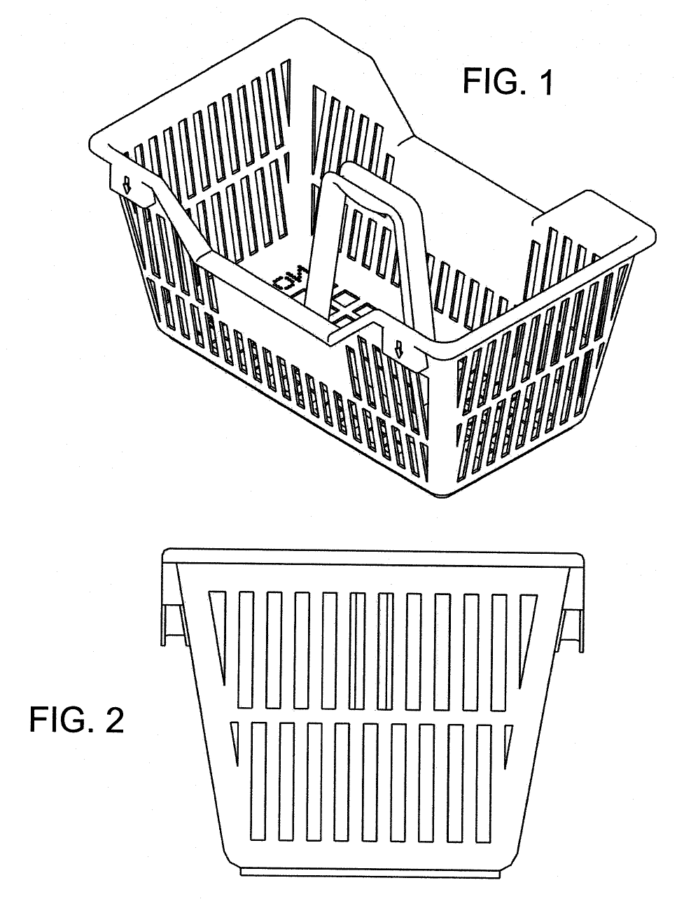

FIG. 1 represents the perspective view of the basket;

FIG. 2 represents the side view of the basket;

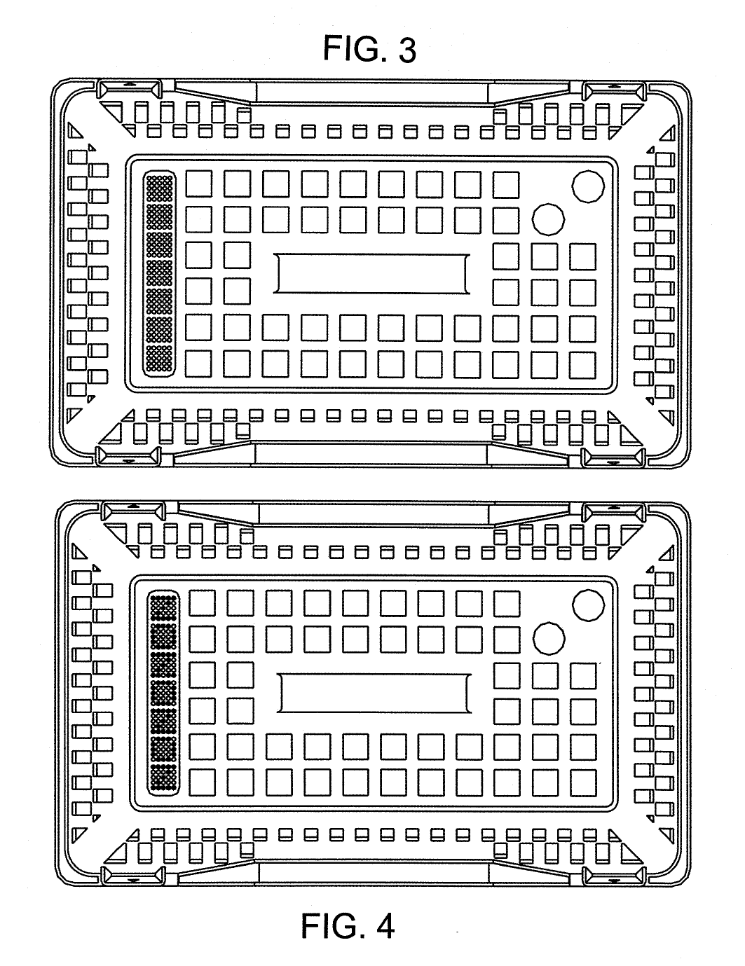

FIG. 3 represents the bottom view of the basket without owner identification.

FIG. 4 represents the bottom view of the basket with owner identification engraved.

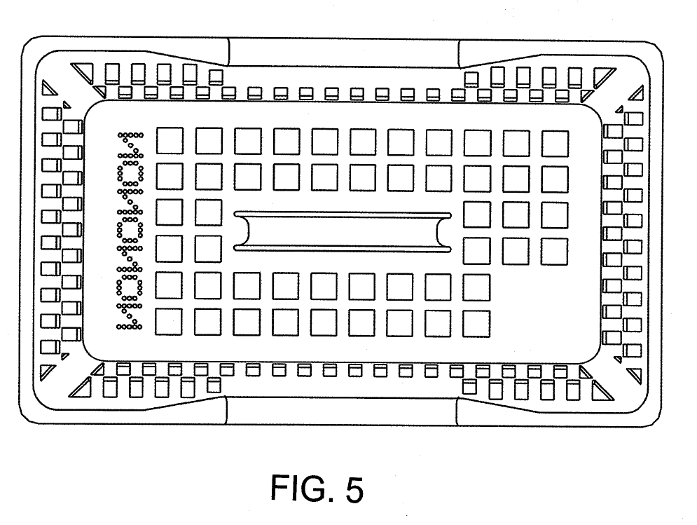

FIG. 5 represents the top view of the basket with owner identification engraved.

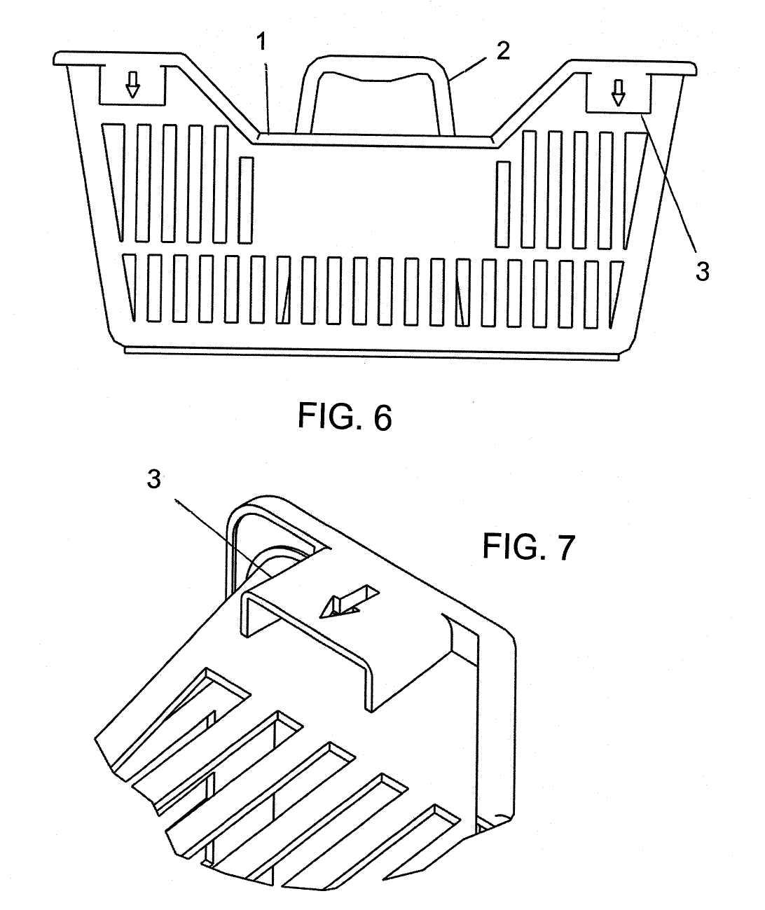

FIG. 6 represents the side view of the basket.

FIG. 7 represents the basket attachment to the car detail.

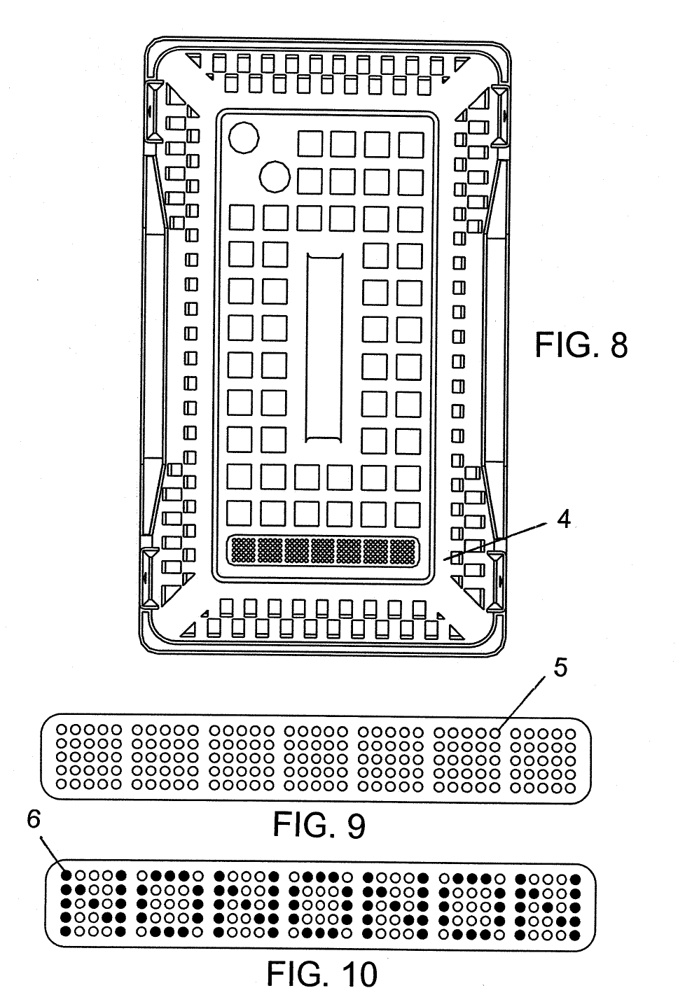

FIG. 8 represents the top view of the basket without owner identification.

FIG. 9 presents the detail of the basket without owner identification.

FIG. 10 presents the engraving system detail already identifying the car owner.

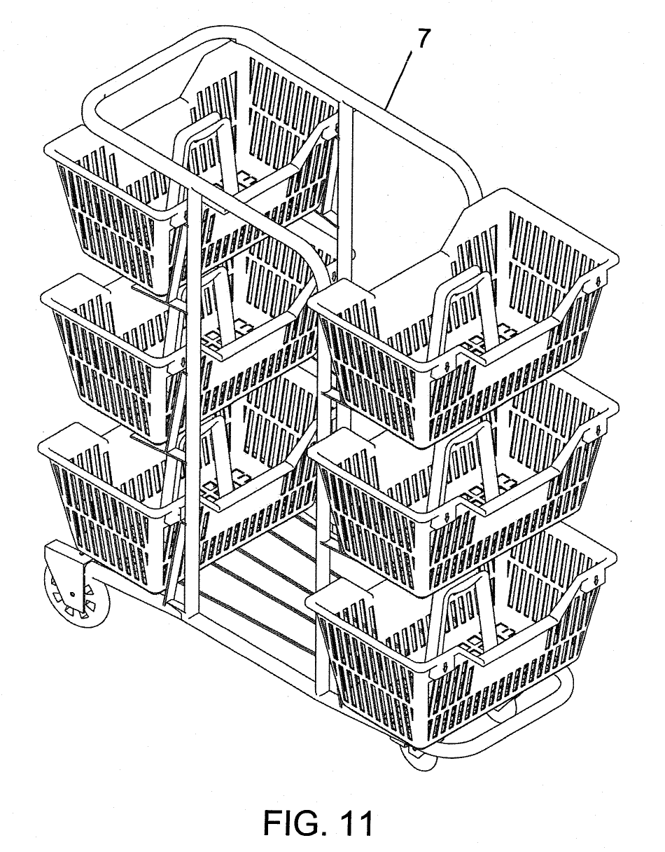

FIG. 11 presents the basket in use attached to the supermarket car.

As illustrated by the figures listed above, the plastic basket model to be attached to supermarket car, object to the present patent, consists of a hollow one piece, with central anatomical handle (2), part of its side wall lowered (1) to ease the placement of goods. There are two supports (3) at each one of its side walls, allowing the perfect attachment to the supermarket car (7). At the bottom of the basket (4), the owner may use the semi-hollow circles (5) to engrave its name (6) with the aid of a screwdriver.

This way, the basket object to this patent works as the usual ones, that is, for small purchases, being carried by the consumer itself, or attached to the supermarket car.

What is claimed is:

1-5. (canceled)

6. Shop basket to be attached to a supermarket car comprising a substantially rectangular one piece basket, having a central handle, two supports at least at one side wall of the basket, a recess in an upper edge of one side wall of the basket, and small areas at a bottom of the basket which can be punched out to display letters, numbers and designs.

7. Shop basket to be attached to a supermarket car comprising small areas at a bottom of the basket which can be punched out to display letters, numbers and designs.

8. Shop basket to be attached to a supermarket car according to claim 7, further comprising a central handle which permits the basket to be carried with one hand.

9. Shop basket to be attached to a supermarket car according to claim 7, further comprising a recess in an upper edge of opposite side walls of the basket, which allows goods to be easily placed in the basket.

10. Shop basket to be attached to a supermarket car according to claim 7, further comprising two supports at each of opposite sides of the basket which allow attachment of the basket to a supermarket car.

11. Shop basket to be attached to a supermarket car according to claim 7, further comprising upwardly diverging side walls that permits stacking of each basket inside another said basket.
